(19) United States
(12) Patent Application Publication
(10) Pub. No.: US 2008/0241725 A1
(43) Pub. Date: Oct. 2, 2008

(54) TONER FOR DEVELOPING AGENT AND METHOD FOR PRODUCING THE SAME

(75) Inventors: Tsutomu Katsumata, Ito-shi (JP); Hiroshi Kawaguchi, Ashigara-gun (JP); Koichi Kuroyama, Kawasaki-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/055,845

(22) Filed: Mar. 26, 2008

(30) Foreign Application Priority Data
Mar. 30, 2007 (JP) 2007-95042

(51) Int. Cl. G03G 9/08

(52) U.S. Cl. 430/108.6

(57) ABSTRACT

In order to solve the foregoing inconveniences, specified addition amounts of a low-resistance external additive and a high-resistance external additive are used in this invention. Furthermore, the toner having been subjected to external addition is subjected to cyclone classification to separate the external additives by force, thereby producing a toner in the same state as in the toner to which a mechanical stress has been applied within the developing unit. When a value of resistance of the toner after externally adding the external additives and a value of resistance of the toner after cyclone classification and a relationship between the both are specified as described later, so far as they fall within the specified ranges, it is possible to provide a developing agent which is free from deterioration of the image quality and is less in toner scattering even by an environmental change or after long-term use.

### BACKGROUND OF THE INVENTION

1 Field of the Invention

The present invention relates to a toner for developing agent and a method for producing the toner for developing agent.

2. Related Art

In a copier with a toner recycle system, a phenomenon in which the charge quantity of a toner varies with the humidity and in particular, the charge quantity is excessively increased at the time of low temperature and low humidity takes place. For the purpose of inhibiting this phenomenon, it is known to add a low-resistance external additive having relatively low resistance to a toner matrix particle or add a high-resistance external additive to a low-resistance toner matrix particle, thereby adjusting a value of resistance of the toner.

However, in the former case, a process in which the low-resistance external additive is separated and becomes a transfer residue, whereby it is incorporated into a recycle toner is repeated. As a result, the concentration of the low-resistance external additive in the recycle toner becomes high as compared with that of the toner before the use, and after a while, defective electrification, fog and toner scattering are caused.

Also, in the latter case, since the high-resistance external additive is separated in the transfer residual toner, a process in which only the low-resistance toner matrix particle is again replenished in a development apparatus is repeated, and after a while, defective electrification occurs, and image failure or toner scattering is caused.

Furthermore, there is disclosed a technology for more effectively improving the charge properties while securing flowability of a toner by externally adding at least two kinds of external additives having a different specific resistance (Ω·cm) to a toner matrix particle (see, for example, JP-A-2003-280254).

In the technology described in the foregoing patent document, an external additive liberation ratio of the free external additive liberated from the matrix particle among external additives having a smaller specific resistance is set up larger than an external additive liberation ratio of the free external additive liberated from the matrix particle. Also, the external additive liberation ratio of the external additive having a smaller specific resistance is set up at not more than 10%. According to this technology, the charge properties are effectively improved while securing the flowability of the toner.

However, in the technology described in the foregoing patent document, stable flowability of the toner and charge properties are not secured over a long period of time. There was involved a problem that when the external additive is separated from the matrix particle with the progress of use of the toner, flowability of the toner and charge properties become worse, whereby the image quality is deteriorated.

### SUMMARY OF THE INVENTION

In order to solve the foregoing inconveniences, the invention has been made. An object of the invention is to provide a toner which is free from deterioration of the image quality and is less in scattering even by an environmental change or after long-term use.

In order to achieve the foregoing object, the invention has been made. The invention is concerned with a toner for developing agent comprising a toner matrix particle containing a binder resin and a coloring agent; a high-resistance external additive to be added to the toner matrix particle and having a value of resistance in the range of from 1.0×10¹² to 9.9×10¹⁸ Ω·cm; and a low-resistance external additive to be externally added to the toner matrix particle and having a value of resistance in the range of from 1.0×10⁵ to 9.9×10¹⁰ Ω·cm, wherein the toner for developing agent has a value of resistance in the range of from 4.0×10¹⁰ to 20×10¹⁰ Ω·cm.

According to the invention, it is possible to provide a toner which is free from deterioration of the image quality and is less in scattering even by an environmental change or after long-term use.

### BRIEF DESCRIPTION OF THE DRAWINGS

FIG. 1 is a diagrammatic view of an image forming apparatus.

FIG. 2 is a toner recycle device of an image forming apparatus.

### DETAILED DESCRIPTION OF THE PREFERRED EMBODIMENTS

An example in which a toner for developing agent according to an embodiment of the invention is applied to an image forming apparatus is hereunder described.

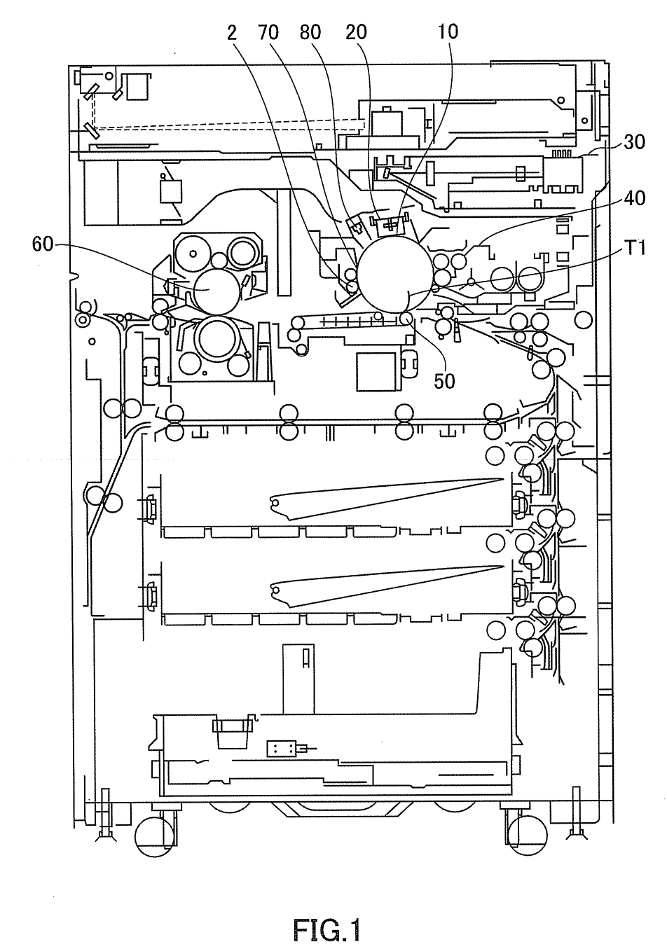

FIG. 1 is a diagrammatic view of an image forming apparatus. A basic configuration of an image forming apparatus is described with reference to FIG. 1. This image forming apparatus is configured of a photoconductive drum 10, a charging unit 20, an exposure device 30, a developing unit 40, a transfer device 50, a fixing device 60, a cleaning device 70, a destaticization device 80 and so on.

In the image forming apparatus having such a configuration, the photoconductive drum 10 is rotatorily driven by a non-illustrated driving section, and its surface is uniformly charged by the charging unit 20. Then, exposure is performed by the exposure device 30 on a basis of read image information, and an electrostatic latent image is formed on a surface of this photoconductive drum 10. This electrostatic latent image is converted into a visible image by a toner to be fed from the developing unit 40.

On the other hand, during the formation of a toner image on this photoconductive drum 10, transfer paper is fed from a paper-feeding section toward the photoconductive drum 10. This transfer paper is sent out into the transfer device 50 disposed opposite to the photoconductive drum 10 at the timing of superimposition on the toner image on the photoconductive drum 10, and the toner image on the photoconductive drum 10 is transferred onto the transfer paper in a transfer section T1.

Thereafter, after mechanical separation from the photoconductive drum 10, the transfer paper is conveyed into the fixing device 60, whereby the toner image is fixed.

The residual toner remaining on the surface of the photoconductive drum 10 after passing through the foregoing transfer section T1 is removed from the photoconductive drum 10 by the cleaning device 70. Then, this toner is conveyed into the developing unit 40 by a toner recycle device 2 and again used. The toner recycle device 2 is hereunder described.

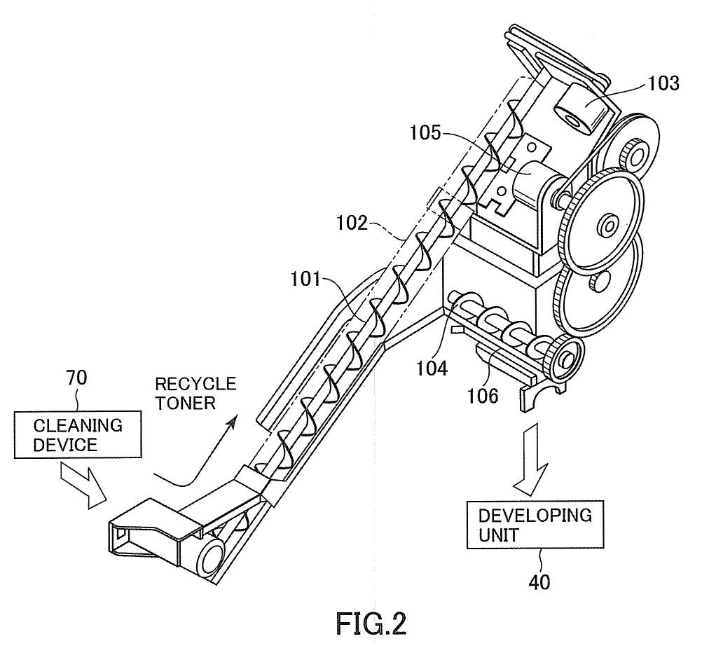

FIG. 2 is a toner recycle device 2 of an image forming apparatus. The recycle toner is removed by the cleaning device 70 and then conveyed into a recycle hopper 104 by an auger 101 within a pipe 102 to be driven by a recycle toner-conveying motor 103. In the recycle hopper 104, the recycle toner is moved to the developing unit 40 by an auger 106 to be driven by a hopper motor 105 and again used. The residual charge on the surface of the photoconductive drum 10 after the transfer residual toner has been removed is removed by the destaticization device 80.

Next, a principle of the invention regarding the toner for developing agent according to an embodiment of the invention is described.

In the toner according to an embodiment of the invention, specified addition amounts of a low-resistance external additive and a high-resistance external additive are externally added to a toner matrix particle. Furthermore, the toner having these external additives externally added thereto is subjected to cyclone classification to separate the external additives by force, thereby producing a toner in the same state as in the toner to which a mechanical stress has been applied within the developing unit. When a value of resistance of the toner after externally adding the external additives and a value of resistance of the toner after cyclone classification and a relationship between the both are specified as described later, so far as they fall within the specified ranges, it is possible to provide a developing agent which is free from deterioration of the image quality and is less in toner scattering even by an environmental change or after long-term use.

Next, a production method of the toner matrix particle is described.

The toner matrix particle of the developing agent can be produced by employing various production methods, for example, a pulverization method and a polymerization method. For example, in the case of producing a toner matrix particle by employing a pulverization method, a coloring agent, a binder resin and a wax and optionally a charge controlling agent are melt kneaded, and the resulting kneaded material is dried, coarsely pulverized, finely pulverized and classified to obtain a toner matrix particle.

Examples of the binder resin which can be used for the toner matrix particle include polyester resins, polystyrene resins, styrene/acrylate copolymer resins, polyester/styrene acrylate copolymer resins and epoxy resins.

Examples of the wax which can be used for the toner matrix particle include natural waxes such as rice wax and carnauba wax; petroleum waxes such as paraffin wax; and synthetic waxes such as fatty acid esters, fatty acid amides, low molecular weight polyethylene and low molecular polypropylene.

Examples of the coloring agent which can be used for the toner matrix particle include carbon black and organic or inorganic pigments and dyes.

Azo based metal-containing dyes, salicylic acid based complexes, nigrosine based dyes, quaternary ammonium salts and the like can be added as the charge controlling agent.

A low-resistance external additive such as titanium oxide and a high-resistance external additive such as silica are externally added onto the surface of the thus obtained toner matrix particle by a Henschel mixer, thereby producing a toner. Here, in order to inhibit the defective electrification to be caused due to the separation of the external additives, an issue of which is of a problem of the related art, it is necessary to control a ratio of resistance of the product and resistance after cyclone classification. The control can be achieved by adjusting an adherence strength between the toner and the external additives. With respect to the present external additives, the adjustment was achieved by the following method.
1. The adjustment of the adherence strength between the toner and the external additives is basically achieved by the revolution number and stirring time of a Henschel mixer.
2. When a higher adherence strength is required, an oil of a necessary temperature is circulated in a jacket of the Henschel mixer to increase the temperature at the external addition, thereby obtaining a high adherence strength.

The toner production method and production apparatus and the like are not particularly limited to the description of the present embodiment.

The thus obtained toner was applied to the image forming apparatus as illustrated in FIG. 1 to obtain an image, and the toner was evaluated on the basis of this image.

With respect to the contents of concrete characteristics and evaluations of the toner, Examples and Comparative Examples are described.

### EXAMPLE 1

0.3 wt % of, as a high-resistance external additive, R974 having a resistance of 5.3×10¹² Ω·cm (manufactured by Nippon Aerosil Co., Ltd.) and 0.2 wt % of, as a low-resistance external additive, NKT90 having a resistance of 1.3×10¹⁰ Ω·cm (manufactured by Nippon Aerosil Co., Ltd.) were externally added onto the surface of the thus obtained toner matrix particle by using a Henschel mixer.

On that occasion, with respect to the external addition condition, the revolution number of the Henschel mixer was 1,800 rpm; the revolution time of the Henschel mixer was 5 minutes; and the temperature of an oil flowing in the Henschel mixer was 35° C.

As a result of measuring the resistance of the thus obtained toner after adding the external additives, a value of resistance of 4×10¹⁰ Ω·cm was obtained. Next, this toner was subjected to cyclone classification. As a result of measuring the resistance after cyclone classification, a value of resistance of 4.2×10¹⁰ Ω·cm was obtained. A ratio of the value of resistance of the toner and the value of resistance of the toner after cyclone classification was determined and found to be 1.05 times. Table 1 shows toner formulations and physical properties of resistance.

TABLE 1

| | | | | | | | Addition | | Addition | Resistance |
|---|---|---|---|---|---|---|---|---|---|---|
| | | | | | | | amount of | | amount | of |
| | | | | | | | high- | | of low- | low- |
| | | Resistance | | Revolu- | | | resistance | Resistance of | resistance | resistance |
| | Resistance | after cyclone | | tion | Revolution | | external | high-resistance | external | external |
| | of product | classification | Ratio | number | time | Temperature | additive | external additive | additive | additive |
| | 10¹⁰ [Ω · cm] | 10¹⁰ [Ω · cm] | [times] | [rpm] | [min] | [° C.] | [%] | [Ω · cm] | [%] | [Ω · cm] |
| Example 1 | 4 | 4.2 | 1.05 | 1800 | 5 | 35 | 0.3 | 5.3 × 10¹² | 0.2 | 1.3 × 10¹⁰ |
| Example 2 | 4 | 6 | 1.5 | 1500 | 6 | 25 | 1.0 | 1.2 × 10¹⁸ | 0.5 | 7.5 × 10⁵ |
| Example 3 | 20 | 21 | 1.05 | 1800 | 4 | 25 | 0.3 | 5.3 × 10¹² | 0.2 | 1.3 × 10¹⁰ |
| Example 4 | 20 | 30 | 1.5 | 2100 | 5 | 35 | 1.3 | 1.2 × 10¹⁸ | 0.5 | 7.5 × 10⁵ |
| Example 5 | 10 | 13 | 1.3 | 1800 | 6 | 35 | 0.8 | 2.4 × 10¹⁶ | 0.3 | 3.6 × 10⁸ |
| Comparative | 4.1 | 4.2 | 1.02 | 1800 | 6 | 25 | 0.3 | 5.3 × 10¹² | 0.1 | 6.4 × 10¹⁰ |
| Example 1 | | | | | | | | | | |
| Comparative | 20 | 34 | 1.7 | 1800 | 5 | 25 | 1.0 | 1.2 × 10¹⁸ | 0.7 | 8.2 × 10³ |
| Example 2 | | | | | | | | | | |
| Comparative | 25 | 35 | 1.4 | 2100 | 4 | 25 | 0.7 | 1.2 × 10¹⁸ | 0.7 | 7.5 × 10⁵ |
| Example 3 | | | | | | | | | | |
| Comparative | 3.8 | 4 | 1.05 | 1500 | 6 | 35 | 0.3 | 5.3 × 10¹² | 0.2 | 1.3 × 10¹⁰ |
| Example 4 | | | | | | | | | | |
| Comparative | 22 | 37 | 1.7 | 2100 | 4 | 25 | 1.5 | 2.6 × 10²⁰ | 0.5 | 7.5 × 10⁵ |
| Example 5 | | | | | | | | | | |
| Comparative | 4 | 4.1 | 1.03 | 1800 | 6 | 35 | 0.2 | 3.5 × 10¹⁰ | 0.2 | 1.3 × 10¹⁰ |
| Example 6 | | | | | | | | | | |
| Comparative | 4.1 | 6 | 1.46 | 1500 | 6 | 25 | 0.5 | 5.3 × 10¹² | 1.0 | 7.5 × 10⁵ |
| Example 7 | | | | | | | | | | |

Here, for the measurement of resistance of the toner, an LCR meter, manufactured by Ando Electric Co., Ltd. was used. Also, with respect to the resistance of the external additive, the external additive was filled in a cell covered by an insulating material; electrodes were disposed so as to come into contact with the filled external additive; and a voltage was applied between the electrodes by using a constant voltage constant pressure device. On that occasion, the voltage applied to the cell and the current as flown were measured, and the resistance was measured.

Next, 5 wt % of the foregoing toner was mixed with 95 wt % of a resin-coated ferrite particle in a tumbler mixer to produce a two-component developing agent.

This developing agent was subjected to paper-passing with 200, 000 sheets (hereinafter referred to as “200K sheets”) by using the previously described image forming apparatus. As a result, there were no problems in evaluation items including environmental dependency, life end white fog, conveyance failure of developing unit, toner scattering and ID.

The evaluation results of the toner are shown in Table 2.

TABLE 2

| | | | Conveyance | | |
|---|---|---|---|---|---|
| | | | failure of | | |
| | Environmental | Life end | developing | Toner | |
| | dependency | white fog | unit | scattering | ID |
| Example 1 | ◯ | ◯ | ◯ | ◯ | ⊚ |
| Example 2 | ◯ | ◯ | ⊚ | ◯ | ◯ |
| Example 3 | ◯ | ⊚ | ◯ | ⊚ | ◯ |
| Example 4 | ◯ | ◯ | ⊚ | ◯ | ◯ |
| Example 5 | ◯ | ⊚ | ⊚ | ⊚ | ⊚ |
| Comparative | X | ◯ | X | ◯ | ◯ |
| Example 1 | | | | | |
| Comparative | ◯ | X | ◯ | X | X |
| Example 2 | | | | | |
| Comparative | ◯ | ◯ | ◯ | ◯ | X |
| Example 3 | | | | | |
| Comparative | ◯ | X | ◯ | X | ◯ |
| Example 4 | | | | | |
| Comparative | ◯ | X | ◯ | X | X |
| Example 5 | | | | | |
| Comparative | ◯ | ◯ | X | ◯ | ◯ |
| Example 6 | | | | | |
| Comparative | ◯ | X | ◯ | X | ◯ |
| Example 7 | | | | | |

With respect to the results of the respective evaluation items, the test methods are hereunder described.

### Evaluation of Environmental Dependency:

The case where a difference in the charge quantity under a low-temperature low-humidity condition and under a high-temperature high-humidity condition was within 15 μC/g is designated as “◯”, whereas the case where it exceeded 15 μC/g is designated as “×”

### Evaluation of Life End White Fog:

After paper-passing with 200K sheets by using the foregoing image forming apparatus, a reflectance of paper before and after paper-passing was measured by using Minolta's spectrophotometer. The case where a difference in the reflectance before and after paper-passing was not more than 2.5% is designated as “◯”, whereas the case where it exceeded 2.5% is designated as “×”. Notably, the case where a it was less or equal 2.0% is designated as “◯”.

### Conveyance Failure of Developing Unit:

Using the developing agent after paper-passing with 200K sheets by using the foregoing image forming apparatus, solid printing was carried out under a high-temperature and high-humidity condition, and an image density was measured at nine point by using RD918, manufactured by Gretag Macbeth. The case where a Min-Max value of the image density at nine points was less than 0.1 is designated as “◯”, whereas the case where it was 0.1 or more is designated as “×”, Notably, the case where it was less than 0.05 is designated as “⊚”.

### Toner Scattering:

During paper-passing with 200K sheets by using the foregoing image forming apparatus, the case where the toner did not fall down on the paper is designated as “◯”, whereas the case where the toner fell down on the paper is designated as “×”. Notably, the case where the toner did not fall down on the paper and life end white fog was less is designated as “⊚”.

### ID:

As a result of measuring an image density by using RD918, manufactured by Gretag Macbeth, the case where the image density was 1.3 or more is designated as “◯”, whereas the case where it was less than 1.3 is designated as “×”. Notably, the case where it was greater or equal 1.5 is designated as “⊚”.

### EXAMPLES 2 TO 5

Next, the toners as shown in Table 1 were produced in the same method as in Example 1. On that occasion, by changing the addition amount and value of resistance of the high-resistance external additive and the addition amount and value of resistance of the low-resistance external additive, any given influence was examined. Also, the value of resistance of the toner and the value of resistance of the toner after cyclone classification were measured.

All of the toners as produced in Examples 2 to 5 were satisfied with the points of environmental dependency, life end white fog, conveyance failure of developing unit, toner scattering and ID. Specially, the toner as produced in Examples 5 was significantly satisfied with these points. It was noted that these toners have the following characteristic features.

A value of resistance of the toner falls within the range of from 4.0×10¹⁰ to 20×10¹⁰ Ω·cm.

A value of resistance of the high-resistance external additive falls within the range of from 1.0×10¹² to 9.9×10¹⁸ Ω·cm.

A value of resistance of the low-resistance external additive falls within the range of from 1.0×10⁵ to 9.9×10¹⁰ Ω·cm.

A value of resistance of the toner after cyclone classification falls within the range of from 4.2×10¹⁰ to 30×10¹⁰ Ω·cm.

A ratio of the value of resistance of the toner after cyclone classification and the value of resistance of the toner falls within the range of from 1.05 to 1.50.

The addition amount of the high-resistance external additive falls within the range of from 0.3 to 1.3 wt %.

The addition amount of the low-resistance external additive falls within the range of from 0.2 to 0.5 wt %.

### COMPARATIVE EXAMPLE 1

0.3 wt % of a high-resistance external additive having a resistance of 5.3×10¹² Ω·cm and 0.1 wt % of a low-resistance external additive having a resistance of 6.4×10¹² Ω·cm were externally added on a toner matrix particle as produced in the same manner as in Example 1 by using a Henschel mixer. As a result of measuring the resistance of the thus obtained toner, a value of 4.1×10¹⁰ Ω·cm was obtained. Next, this toner was subjected to cyclone classification. On that occasion, with respect to the external addition condition, the revolution number of the Henschel mixer was 1,800 rpm, and the revolution time of the Henschel mixer was 6 minutes. Measurement of the resistance after cyclone classification gave a value of 4.2×10¹⁰ Ω·cm. At this time, a ratio of the value of resistance of the toner after cyclone classification to the value of resistance of the toner was determined and found to be 1.02.

Next, 5 wt % of the foregoing toner was mixed with 95 wt % of a resin-coated ferrite particle in a tumbler mixer to produce a two-component developing agent. As shown in Table 2, as a result of subjecting this developing agent to paper-passing with 200K sheets by using an image forming apparatus, there were no problems with respect to the life end white fog, toner scattering and ID; however, the conveyance failure of developing unit and environmental dependency became worse.

In the present Comparative Example, since the addition amount of the low-resistance external additive is low, the flowability of the toner was poor so that the conveyance failure of developing unit occurred. Also, with respect to the environmental dependency, in view of the matter that the addition amount of the low-resistance external additive is low, whereas a large amount of the high-resistance external additive is added, it is considered that the charge quantity at low temperature and low humidity was high, whereby the environmental dependency became worse.

### COMPARATIVE EXAMPLE 2

A toner having physical properties as shown in Comparative Example 2 in Table 1 was produced in the same method as in Comparative Example 1. Next, 5 wt % of the foregoing toner was mixed with 95 wt % of a resin-coated ferrite particle in a tumbler mixer to produce a two-component developing agent. This two-component developing agent was subjected to paper-passing with 200K sheets by using the same image forming apparatus as in Comparative Example 1. As a result, the ID was insufficient, and the life end white fog and toner scattering became worse.

In the present Comparative Example, it is considered that since the resistance of the toner after cyclone classification is high, the foregoing inconveniences occurred.

### COMPARATIVE EXAMPLE 3

A toner having physical properties as shown in Comparative Example 3 in Table 1 was produced in the same method as in Comparative Example 1. Next, 5 wt % of the foregoing toner was mixed with 95 wt % of a resin-coated ferrite particle in a tumbler mixer to produce a two-component developing agent. This two-component developing agent was subjected to paper-passing with 200K sheets by using the same image forming apparatus as in Comparative Example 1. As a result, the ID was lowered.

In the present Comparative Example, it is considered that since the values of resistance of the toner and the toner after cyclone classification are higher than the specified values, the charge quantity increased and the defective electrification occurred, whereby the ID was lowered.

### COMPARATIVE EXAMPLE 4

A toner having physical properties as shown in Comparative Example 4 in Table 1 was produced in the same method as in Comparative Example 1. Next, 5 wt % of the foregoing toner was mixed with 95 wt % of a resin-coated ferrite particle in a tumbler mixer to produce a two-component developing agent. This two-component developing agent was subjected to paper-passing with 200K sheets by using the same image forming apparatus as in Comparative Example 1. As a result, the life end white fog and toner scattering became worse.

In the present Comparative Example, in view of the matter that the values of resistance of the toner and the toner after cyclone classification are low, it is considered that the charge quantity was low and the defective electrification occurred, whereby the foregoing inconveniences occurred.

### COMPARATIVE EXAMPLE 5

A toner having physical properties as shown in Comparative Example 5 in Table 1 was produced in the same method as in Comparative Example 1. Next, 5 wt % of the foregoing toner was mixed with 95 wt % of a resin-coated ferrite particle in a tumbler mixer to produce a two-component developing agent. This two-component developing agent was subjected to paper-passing with 200K sheets by using the same image forming apparatus as in Comparative Example 1. As a result, the life end white fog became worse, and the ID was insufficient.

In the present Comparative Example, in view of the matters that the value of resistance of the toner is high and that the ratio before and after cyclone classification is high, it is considered that the charge quantity increased, whereby the ID was insufficient. Also, since the charge quantity is high, the defective electrification occurred, and the life end white fog became worse.

### COMPARATIVE EXAMPLE 6

A toner having physical properties as shown in Comparative Example 6 in Table 1 was produced in the same method as in Comparative Example 1. Next, 5 wt % of the foregoing toner was mixed with 95 wt % of a resin-coated ferrite particle in a tumbler mixer to produce a two-component developing agent. This two-component developing agent was subjected to paper-passing with 200K sheets by using the same image forming apparatus as in Comparative Example 1. As a result, the conveyance failure of developing unit, life end white fog became worse and toner scattering became worse.

In the present Comparative Example, the addition amount of the high-resistance external additive is not satisfied with the requirement. For that reason, it is considered that the flowability of the toner was poor so that the conveyance failure of developing unit occurred. Furthermore, since the value of resistance of the toner is low and the charge quantity is low, it is considered that the defective electrification occurred, whereby the life end white fog and toner scattering became worse.

### COMPARATIVE EXAMPLE 7

A toner having physical properties as shown in Comparative Example 2 in Table 1 was produced in the same method as in Comparative Example 1. Next, 5 wt % of the foregoing toner was mixed with 95 wt % of a resin-coated ferrite particle in a tumbler mixer to produce a two-component developing agent. This two-component developing agent was subjected to paper-passing with 200K sheets by using the same image forming apparatus as in Comparative Example 1. As a result, the life end white fog and toner scattering became worse.

In the present Comparative Example, since the addition amount of the low-resistance external additive is high, the defective electrification occurred, whereby the life end white fog and toner scattering became worse.

What is claimed is:

1. A toner for developing agent comprising:
a toner matrix particle containing a binder resin and a coloring agent;
a high-resistance external additive to be externally added to the toner matrix particle and having a value of resistance in the range of from 1.0×10¹² to 9.9×10¹⁸ Ω·cm; and
a low-resistance external additive to be externally added to the toner matrix particle and having a value of resistance in the range of from 1.0×10⁵ to 9.9×10¹⁰ Ω·cm,
wherein the toner for developing agent has a value of resistance in the range of from 4.0×10¹⁰ to 20×10¹⁰ Ω·cm.

2. The toner for developing agent according to claim 1, wherein a value of resistance of the toner having been subjected to cyclone classification is in the range of from 4.2 to 30×10¹⁰ Ω·cm.

3. The toner for developing agent according to claim 1 or 2, wherein a ratio of the value of resistance of the toner having been subjected to cyclone classification to the value of resistance of the toner is in the range of from 1.05 to 1.50.

4. The toner for developing agent according to any one of claims 1 to 3, wherein the addition amount of the high-resistance external additive is in the range of from 0.3 to 1.3 wt %.

5. The toner for developing agent according to any one of claims 1 to 4, wherein the addition amount of the low-resistance external additive is in the range of from 0.2 to 0.5 wt %.

6. The toner for developing agent according to any one of claims 1 to 5, wherein the high-resistance external additive is silica, and the low-resistance external additive is titanium oxide.

7. A method for producing a toner composed of a toner matrix particle containing a binder resin and a coloring agent and external additives, which comprises the steps of:
externally adding a high-resistance external additive having a value of resistance in the range of from 1.0×10¹² to 9.9×10¹⁸ Ω·cm;
externally adding a low-resistance external additive having a value of resistance in the range of from 1.0×10⁵ to 9.9×10¹⁰ Ω·cm; and
wherein a value of resistance of the toner is adjusted in the range of from 4.0×10¹⁰ to 20×10¹⁰ Ω·cm.
